(19) United States
(12) Patent Application Publication
(10) Pub. No.: US 2013/0263039 A1
(43) Pub. Date: Oct. 3, 2013

(54) CHARACTER STRING SHORTCUT KEY

(71) Applicants: Anton Olof Fahlgren, San Francisco, CA (US); Petru Motrescu, Helsinki (FI); Johannes Rastas, Espoo (FI)

(72) Inventors: Anton Olof Fahlgren, San Francisco, CA (US); Petru Motrescu, Helsinki (FI); Johannes Rastas, Espoo (FI)

(73) Assignee: NOKIA CORPORATION, Espoo (FI)

(21) Appl. No.: 13/435,742

(22) Filed: Mar. 30, 2012

(51) Int. Cl. G06F 3/048

(52) U.S. Cl. 715/780

(57) ABSTRACT

An apparatus comprising:

at least one processor; and

at least one memory including computer program code,

the at least one memory and the computer program code configured to, with the at least

one processor, cause the apparatus to perform at least the following:
during highlighting of a character string, enable association of the highlighted character string with a single shortcut key; and
enable entering of the associated character string into a text field of an application in response to the single shortcut key being actuated.

### TECHNICAL FIELD

The present disclosure relates to the field of user interfaces which can provide shortcuts in character entry, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

It is common for electronic devices to provide a user interface (e.g. a graphical user interface). A user interface may enable a user to interact with an electronic device, for example, to open applications using application icons, enter commands, to select menu items from a menu, or to enter characters using a virtual keypad. To enter character strings, the user may be provided with a physical or virtual keyboard.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect there is provided an apparatus comprising:

at least one processor; and

at least one memory including computer program code,

the at least one memory and the computer program code configured to, with the at least

one processor, cause the apparatus to perform at least the following:
during highlighting of a character string, enable association of the highlighted character string with a single shortcut key; and
enable entering of the associated character string into a text field of an application in response to the single shortcut key being actuated.

A character string may comprise a series of one or more characters in a particular order.

A character may comprise a combination of one or more of a word, a letter character (e.g. from the Roman, Greek, Arabic or Cyrillic alphabets), a graphic character (e.g. a sinograph, Japanese kana or Korean delineation), a phrase, a syllable, a diacritical mark, an emoticon, and a punctuation mark. A character string may comprise a combination of one or more of: a word; a sentence; a phrase; a free morpheme; a bound morpheme; a root character string; a stem character string; an affix; a prefix and a suffix.

A character string may be recognised by the apparatus/electronic device using one or more delimiters (e.g. spaces, punctuation marks, capital letters, tab character, return character, or another control character), the delimiters being associated with the beginning and/or end of the character string.

The highlighted character string may have been entered by the user of an electronic device. The highlighted character string may not have been entered by the user of the electronic device (e.g. it may have been received from a remote server or via the internet or other network).

Highlighting may be considered to be enabling provisional selection of a character string. Highlighting may comprise indicating to the user which characters are highlighted (e.g. by changing the colour of the characters, or providing an indicator). Highlighting a character string may comprise distinguishing the characters of the highlighted character string with respect to other characters (e.g. by making the highlighted characters a different colour to at least one other non-highlighted character). Highlighting may or may not comprise providing one or more of an audio indication (e.g. a beep, or a message announcing the highlighted item), a visual indication and a tactile (e.g. haptic feedback) indication.

The apparatus may be configured to provide the enablement of the association during the presentation of a virtual keyboard to a user.

The apparatus may be configured to, during the highlighting of the character string, provide a pop-up menu, or pop-up window to allow selection of the character string for association with the single shortcut key.

The apparatus may be configured to, during the highlighting of the character string, provide a pop-up menu comprising at least two selectable options, a first selectable option allowing selection of the character string for association with the single shortcut key and the second selectable option allowing selection of the character string for storage in a copy memory (e.g. a clipboard) for later pasting.

The apparatus may be configured to, during the highlighting of the character string, allow selection of the character string for association with the single shortcut key.

The apparatus may be configured to assign a subsequent selected character string to the same single shortcut key to replace the previously assigned character string for the single shortcut key. That is, a new association between a second character string and a single shortcut may be considered to overwrite a previous association between a first character string and the single shortcut key. This may allow the same shortcut key to be reused. This may be particularly advantageous in embodiments comprising a limited number of single shortcut keys.

The apparatus may be configured to assign a subsequent selected character string to a different single shortcut key.

The single shortcut key may be a newly created virtual key not available prior to the association.

The single shortcut key may be a newly created virtual key not available prior to the association, the single shortcut key configured to populate a personal virtual keyboard.

The single shortcut key may be a newly created virtual key not available prior to the association, the single shortcut key configured to populate a personal virtual keyboard, the personal virtual keyboard configured to be accessible using an existing virtual key from a standard virtual keyboard. The existing virtual key can be created with the association of the character string with the single shortcut key.

A keyboard (e.g. a virtual or physical keyboard) may comprise an alphanumeric keyboard, a numeric keyboard or an alphabetic keyboard.

The single shortcut key may form part of a physical/virtual keyboard. The keyboard may comprises one or more of alphabetic keys, the alphabetic keyboard enabling each letter of an alphabet (e.g. Roman alphabet, Greek alphabet, Arabic alphabet, Hebrew alphabet, Syriac alphabet, Aramaic alphabet, Hangul alphabet) to be entered.

The single shortcut key may comprise an indication of at least part of the character string which can be entered. This may be readily possible for virtual keys on a virtual keyboard. The indication may allow the user to recognise which character string is associated with the particular single shortcut key.

The apparatus may be configured to provide feedback on a selected association of the character string with the single shortcut key following the association. That is, the apparatus may be configured to provide confirmation of the association of the character string with the single shortcut key following the association. The confirmation may be considered to be an indication that the association has occurred. The confirmation may be provided visually (e.g. using text or an image), or using audio (e.g. an audio message) or tactile (e.g. haptic) feedback.

The apparatus may be configured to provide the enablement of the association with a single shortcut key at an operating system level common for a plurality of applications of an electronic device.

The plurality of applications configured to run on the operating system may comprise a combination of two or more web browser applications, messaging applications (e.g. for SMS, MMS, messaging), email applications, videoconferencing applications, word processing applications, spreadsheet applications, calendar applications, and file storage applications. For example, the plurality of applications may comprise two web-browser applications, or an email application and a calendar application. For example, the plurality of applications may comprise an email application and a messaging application, or two web browser applications.

The operating system may be considered to be one or more computer programs that manage computer hardware resources and/or provide common services for application software. Each of the plurality of applications may be configured to run on the operating system. Examples of operating systems may include, for example, Microsoft Windows (for desktops/mobile phones), Apple OS (e.g. Mac OS X), Android, and Symbian.

The single shortcut key may be available for entry of the character string in a different application to the application from which it was highlighted for association. For example, the character string may be highlighted for association in an email application, and available for entry in a web browser application.

The association may be configured to persist after the application from which the character string was highlighted for association is closed and/or the device/apparatus is shut down and restarted.

The apparatus may be configured to automatically highlight the character string during active entry of the character string in a particular field of a particular application.

The particular field may be an email address field.

The apparatus may be configured to automatically highlight the character string during entry of a character string if the entered character string satisfies a particular predetermined length criterion or a predetermined character type criterion.

The predetermined character type criterion may include the recognition of types of character (e.g. numbers, symbols, letters, upper case letters, lower case letters). The predetermined character type criterion may include the recognition of particular characters, for example, one or more of “@”, “_”, or “-” in the character string.

The predetermined character type criterion may include the recognition of different types of character in the entered character string. The different types of character may include combinations of letters and numbers, text and symbols, lower case and upper case characters.

The apparatus may be configured to determine that multiple keyboards have been used in the character entry prior to automatically providing highlighting the character string for association to a single key.

The single shortcut key may be a physical key of a physical keyboard.

The apparatus may be configured such that the association is done for a selected character string on a first electronic device for use by a single key of a keyboard on a second electronic device.

The apparatus may be configured to enable the character string to be entered in a position corresponding to a content-entry cursor (e.g. a text-entry cursor).

The apparatus may be a portable electronic device, a laptop computer, a mobile phone, a Smartphone, a tablet computer, a personal digital assistant, a digital camera, a watch, a server, or a module/circuitry for one or more of the same a non-portable electronic device, a desktop computer, a monitor, a server, or a module/circuitry for one or more of the same.

In a further aspect there is provided a method, the method comprising:
during highlighting of a character string, enabling association of the highlighted character string with a single shortcut key; and
enabling entering of the associated character string into a text field of an application in response to the single shortcut key being actuated.

In a further aspect there is provided a computer program comprising computer program code, the computer program code being configured to perform at least the following:
during highlighting of a character string, enable association of the highlighted character string with a single shortcut key; and
enable entering of the associated character string into a text field of an application in response to the single shortcut key being actuated.

The computer program may be stored on a storage media (e.g. on a CD, a DVD, a memory stick or other non-transitory medium). The computer program may be configured to run on a device or apparatus as an application. An application may be run by a device or apparatus via an operating system. The computer program may form part of a computer program product.

In a further aspect there is provided an apparatus, the apparatus comprising:
means for enabling configured to, during highlighting of a character string, enable association of the highlighted character string with a single shortcut key; and
means for enabling configured to enable entering of the associated character string into a text field of an application in response to the single shortcut key being actuated.

In a further aspect there is provided an apparatus comprising:

at least one processor; and

at least one memory including computer program code,

the at least one memory and the computer program code configured to, with the at least one processor, cause the apparatus to perform at least the following:
during selection of a character string, provide for association of the selected character string with a character string shortcut, the character string shortcut selectable from a menu of shortcuts in addition to one or more of cut and paste shortcuts; and
enable entering of the associated character string into a text field of an application of an electronic device in response to the character string shortcut being actuated.

The present disclosure includes one or more corresponding aspects, embodiments or features in isolation or in various combinations whether or not specifically stated (including claimed) in that combination or in isolation. Corresponding means and corresponding function units (e.g. first enabler, second enabler) for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 depicts an example embodiment comprising a number of electronic components, including memory and a processor.

FIG. 2 depicts an example embodiment comprising a number of electronic components, including memory, a processor and a communication unit.

FIG. 3 depicts an example embodiment comprising a number of electronic components, including memory, a processor and a communication unit.

FIG. 4a-4d depicts an example embodiment wherein the single shortcut key is provided in a personal keyboard.

FIG. 5a-5f depicts a further example embodiment wherein the single shortcut key is provided by a virtual key.

FIGS. 6a-6f depicts the example embodiment wherein the location single shortcut key is provided by a newly created virtual key.

FIGS. 7a-7b illustrate an example apparatus in communication with a remote server/cloud.

FIG. 8 illustrates a flowchart according to an example method of the present disclosure.

FIG. 9 illustrates schematically a computer readable medium providing a program.

### DESCRIPTION OF EXAMPLE ASPECTS/EMBODIMENTS

It is common for an electronic device to have a user interface (which may or may not be graphically based) to allow a user to interact with the device to enter and/or interact with information. For example, the user may use a keyboard user interface to enter text to provide, for example, textual information. Particularly if the user interface is restricted (e.g. limited in terms of user interface elements such as keys, or in terms of area), the user may have to spend a considerable time and effort in performing the same task (e.g. entering an email address or name) repeatedly. For example, a user may have to manually enter text corresponding to an email address in order to send an email and enter the same location text again to update a social networking site.

It may therefore be beneficial to provide a single shortcut key to allow the user to again enter a previously entered character string. This may allow the character string to be entered using fewer keystrokes, gestures, and/or commands. Example embodiments contained herein may be considered to associate a highlighted character string with a single shortcut key in order to provide for use of the single shortcut key to enable entering the associated character string into a text field.

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

FIG. 1 shows an apparatus (101) comprising memory (107), a processor (108), input I and output O. In this embodiment only one processor and one memory are shown but it will be appreciated that other embodiments may utilise more than one processor and/or more than one memory (e.g. same or different processor/memory types).

In this embodiment the apparatus (101) is an Application Specific Integrated Circuit (ASIC) for a portable electronic device with a touch sensitive display. In other embodiments the apparatus (101) can be a module for such a device, or may be the device itself, wherein the processor (108) is a general purpose CPU of the device and the memory (107) is general purpose memory comprised by the device.

The input I allows for receipt of signalling to the apparatus (101) from further components, such as components of a portable electronic device (like a touch-sensitive display) or the like. The output O allows for onward provision of signalling from within the apparatus (101) to further components. In this embodiment the input I and output O are part of a connection bus that allows for connection of the apparatus (101) to further components.

The processor (108) is a general purpose processor dedicated to executing/processing information received via the input I in accordance with instructions stored in the form of computer program code on the memory (107). The output signalling generated by such operations from the processor (108) is provided onwards to further components via the output O.

The memory (107) (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor (108). The internal connections between the memory (107) and the processor (108) can be understood to, in one or more example embodiments, provide an active coupling between the processor (108) and the memory (107) to allow the processor (108) to access the computer program code stored on the memory (107).

In this example the input I, output O, processor (108) and memory (107) are all electrically connected to one another internally to allow for electrical communication between the respective components I, O, (108, 107). In this example the components are all located proximate to one another so as to be formed together as an ASIC, in other words, so as to be integrated together as a single chip/circuit that can be installed into an electronic device. In other examples one or more or all of the components may be located separately from one another.

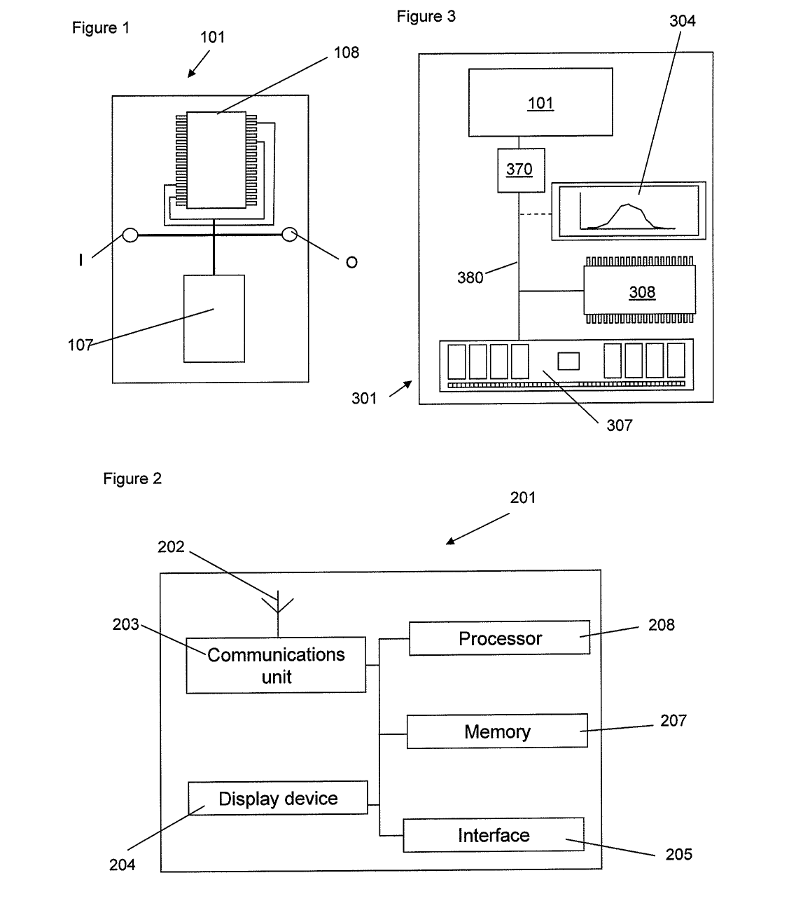

FIG. 2 depicts an apparatus (201) of a further example embodiment, such as a mobile phone. In other example embodiments, the apparatus (201) may comprise a module for a mobile phone (or PDA or audio/video player), and may just comprise a suitably configured memory (207) and processor (208).

The example embodiment of FIG. 2, in this case, comprises a display device (204) such as, for example, a Liquid Crystal Display (LCD) or touch-screen user interface. The apparatus (201) of FIG. 2 is configured such that it may receive, include, and/or otherwise access data. For example, this example embodiment (201) comprises a communications unit (203), such as a receiver, transmitter, and/or transceiver, in communication with an antenna (202) for connecting to a wireless network and/or a port (not shown) for accepting a physical connection to a network, such that data may be received via one or more types of networks. This example embodiment comprises a memory (207) that stores data, possibly after being received via antenna (202) or port or after being generated at the user interface (205). The processor (208) may receive data from the user interface (205), from the memory (207), or from the communication unit (203). It will be appreciated that, in certain example embodiments, the display device (204) may incorporate the user interface (205). Regardless of the origin of the data, these data may be outputted to a user of apparatus (201) via the display device (204), and/or any other output devices provided with apparatus. The processor (208) may also store the data for later use in the memory (207). The memory (207) may store computer program code and/or applications which may be used to instruct/enable the processor (208) to perform functions (e.g. read, write, delete, edit or process data).

FIG. 3 depicts a further example embodiment of an electronic device (301), such as a tablet personal computer, a portable electronic device, a portable telecommunications device, a server or a module for such a device, the device comprising the apparatus (101) of FIG. 1. The apparatus (101) can be provided as a module for device (301), or even as a processor/memory for the device (301) or a processor/memory for a module for such a device (301). The device (301) comprises a processor (308) and a storage medium (307), which are connected (e.g. electrically and/or wirelessly) by a data bus (380). This data bus (380) can provide an active coupling between the processor (308) and the storage medium (307) to allow the processor (308) to access the computer program code. It will be appreciated that the components (e.g. memory, processor) of the device/apparatus may be linked via cloud computing architecture. For example, the storage device may be a remote server accessed via the internet by the processor.

The apparatus (101) in FIG. 3 is connected (e.g. electrically and/or wirelessly) to an input/output interface (370) that receives the output from the apparatus (101) and transmits this to the device (301) via data bus (380). Interface (370) can be connected via the data bus (380) to a display (304) (touch-sensitive or otherwise) that provides information from the apparatus (101) to a user. Display (304) can be part of the device (301) or can be separate. The device (301) also comprises a processor (308) configured for general control of the apparatus (101) as well as the device (301) by providing signalling to, and receiving signalling from, other device components to manage their operation.

The storage medium (307) is configured to store computer code configured to perform, control or enable the operation of the apparatus (101). The storage medium (307) may be configured to store settings for the other device components. The processor (308) may access the storage medium (307) to retrieve the component settings in order to manage the operation of the other device components. The storage medium (307) may be a temporary storage medium such as a volatile random access memory. The storage medium (307) may also be a permanent storage medium such as a hard disk drive, a flash memory, a remote server (such as cloud storage) or a non-volatile random access memory. The storage medium (307) could be composed of different combinations of the same or different memory types.

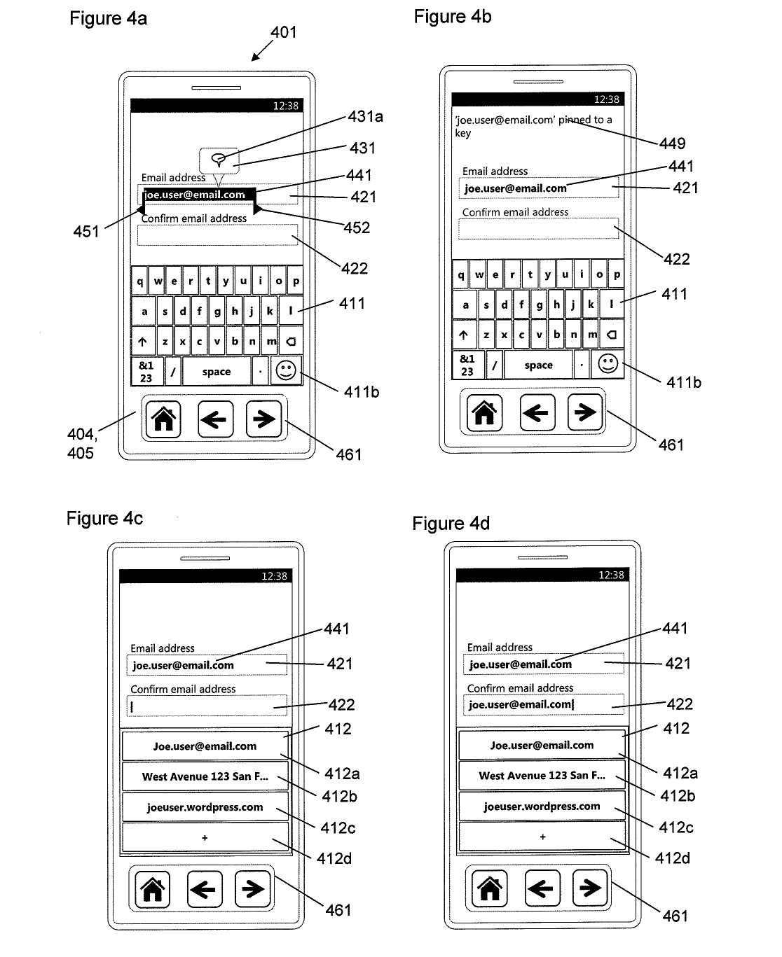

FIGS. 4a-4d depicts an example embodiment of the apparatus depicted in FIG. 2 comprising a portable electronic communications device (401), e.g. such as a mobile phone, with a user interface comprising a touch-screen user interface (405, 404), a memory (not shown), a processor (not shown) and an antenna (not shown) for transmitting and/or receiving data (e.g. emails, textual messages, phone calls, information corresponding to web pages). In this case, the apparatus is configured to: enable association of a highlighted character string with a single shortcut key during highlighting of the character string; and enable entering of the associated character string into a text field of an application in response to the single shortcut key being actuated.

In the situation depicted in FIG. 4a, the device/apparatus is displaying a web browsing application screen corresponding to a running web browsing application. The web browsing application screen comprises a virtual keyboard (411), which in this case is a standard virtual keyboard comprising letter keys (of the Roman alphabet) arranged according to a QWERTY layout; and a navigation icon region (461), configured to allow the user to navigate to different screens provided by the device (e.g. other home and/or application screens). It will be appreciated that other example embodiments may be configured to provide other keyboard layouts. For example, a keyboard or keypad may comprise an alphanumeric key input area, alphabetic key input area, a numeric key input area, an AZERTY key input area, a QWERTY key input area or an ITU-T E.161 key input area.

The web browsing application screen, as depicted in FIG. 4a, also comprises an ‘Email address’ text field (421) and a ‘confirm email address’ text field (422) (e.g. the text fields forming part of an online form). In this example, the user has entered his email address into the ‘Email address’ text field (421) (e.g. using the virtual keyboard (411), by selecting each of the character keys making up the email character string in turn). After the user's email address has been entered as a character string (441) into the ‘Email address’ text field (421), the user has highlighted the entered email address character string (441) by providing a user input via the touch screen (404, 405). The user input, in this case, comprises selecting the first letter of the desired character string using a first finger (or other stylus) and selecting a second letter of the desired email address character string (441) using a second finger (or other stylus). It will be appreciated that for other example embodiments a particular character string may be highlighted in response to other user inputs (e.g. dragging gestures, using a cursor).

In this case, the email address character string (441) is highlighted by changing the background colour of the highlighted characters (from white to black, in this case), and changing the text colour (from black to white, in this case), and by indicating by arrows (451, 452) the extent of the character string. It will be appreciated that, for other example embodiments, a character string may be highlighted in other ways (e.g. the character string may have a different font, be underlined, and/or flash; or the character string may be highlighted using tactile or audio means). When the email address character string (441) is highlighted, a pop-up menu (431) is displayed (as shown in FIG. 4a), the pop-up menu comprising an association icon (431a). This is shown in FIG. 4a.

In this case, the user wishes to associate the highlighted email address character string (441) with a key single shortcut key. To do this, the user selects the association icon (431a) during highlighting of the email character string which associates the highlighted email address character string (441) with a single shortcut key. After the association icon (431a) has been selected this example embodiment is configured to provide a confirmation message (449) confirming the association of the character string ‘joe.user@email.com’ with the single shortcut key (as shown in FIG. 4b). This provides feedback to the user that the association has been performed. This is particularly advantageous when, as in this case, the single key is not part of the keyboard visible at the time of the association.

In this case, the single shortcut key is added to a personal keyboard comprising personal keys, each personal key being associated with a character string. In this case, the user wishes to enter the same email address into the ‘confirm email address’ text field. To do this, the user positions the text entry cursor into the ‘confirm email address’ text field (422) and then switches the keyboard from the QWERTY standard virtual keyboard (411) to the personal keyboard (412), by pressing the personal keyboard access key (411b), the personal keyboard access key forming part of the standard virtual keyboard (411). In other embodiments the personal keyboard access key (411b) may only be provided on the keyboard (411) once at least on character association has been created.

In response to detecting selection of the personal keyboard access key (411b), the apparatus/device is configured to display the personal keyboard (412), as shown in FIG. 4c, the personal keyboard comprising one or more personal keys (412a-412c), each personal key (412a-412c) being associated with a respective character string. That is, in this case, the personal virtual keyboard is configured to be accessible using an existing virtual key (411b) from the standard QWERTY standard virtual keyboard (411). It will be appreciated that for other example embodiments, the personal virtual keyboard may be accessible, for example, in response to detecting a particular user input gesture (e.g. a swipe or multi-touch gesture) or in response to selection of a particular menu item or icon.

In this example embodiment, each personal key (412a-412d) is configured to display a predetermined number of characters of the respective associated character strings. In this way, the single shortcut key (412a) comprises an indication of at least part of the character string which can be entered. In this example, the personal keys (412a-412d) are ordered according to the time they were created, with the more recently created keys being towards the top. In this case, the last created single shortcut key (412a) corresponding to the character string ‘Joe.user@email.com’ is at the top. It will be appreciated that the keys of the personal keyboard may be ordered differently (e.g. in alphabetical order, and/or according to usage). Furthermore, the ordered keys may be arranged differently, e.g. from left to right.

In this example embodiment, the personal keyboard (412) is a scrollable list of personal keys (e.g. scrollable using scroll keys (412d)). The number of keys is dependent on the number of keys created by the user (i.e. in this embodiment, the personal keyboard is expanded as more keys are created). It will be appreciated that other example embodiments may comprise a pre-determined number of keys. In such example embodiments, when all of the keys are associated with a respective character string, when a further association between a character string and a single shortcut key is requested, the apparatus/device may be configured to warn the user, or enable an existing personal key be disassociated with the previous character string and re-associated with the newly requested character string (e.g. in a first in, first out basis, or based on priority and/or the amount of usage of each personal key and/or on user selection).

In this case, the ‘Joe.user@email.com’ personal single shortcut key (412a) is a newly created virtual key which was not available prior to the association, the single shortcut key configured to populate a personal virtual keyboard. That is, prior to the user selecting the association icon (431a) the Joe.user@email.com' personal single shortcut key (412a) would not have formed part of the personal virtual keyboard (412).

In order to enter the character string ‘Joe.user@email.com’ into the ‘confirm email address’ text field (422), the user actuates the ‘Joe.user@email.com’ personal single shortcut key (412a) which enables the associated character string to be entered into the ‘confirm email address’ text field (422) at the position of the text entry cursor (as shown in FIG. 4d).

It will be appreciated that the single shortcut key (412a) may be available for a plurality of applications (e.g. the single shortcut key may be provided at an operating system level common for a plurality of applications of an electronic device). For example, the single shortcut key may be available for entry of a character string in a different application to the application from which it was highlighted for association (e.g. a character string may be highlighted for association with a single shortcut key in an email application, and the associated character string may be entered into a text field of a web browsing application in response to the single shortcut key being actuated).

In this way, the user may create a shortcut key associated with a particular character string without having to navigate away from the particular task he/she is engaged in.

It will be appreciated that the single shortcut key may be configured to persist after the application from which the character string was highlighted for association is closed and/or after the apparatus/device is turned off and restarted.

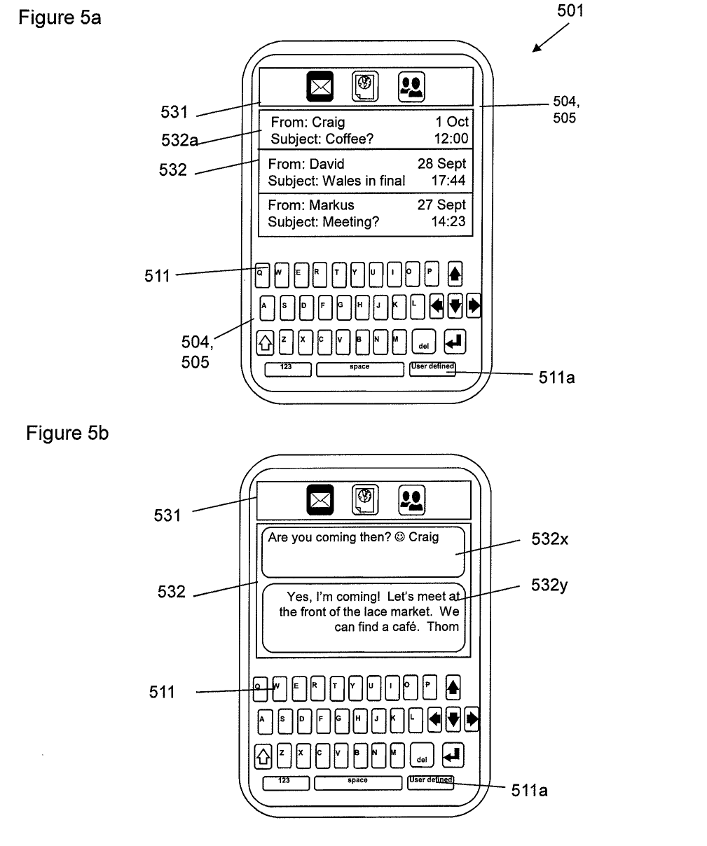

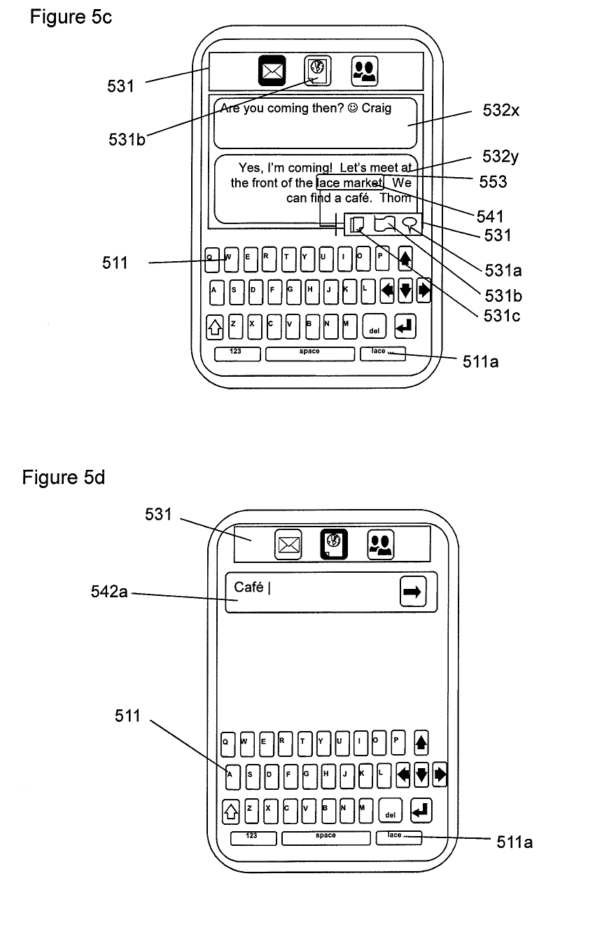

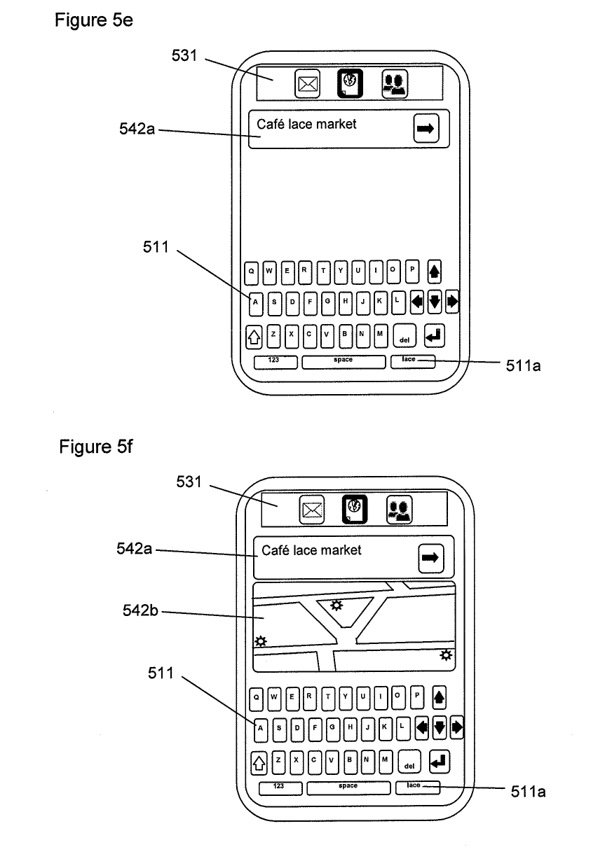

FIGS. 5a-5f depict a further example embodiment comprising a portable electronic device (501), e.g. such as a mobile phone, with a user interface comprising a touch-screen user interface (505, 504), a memory (not shown), a processor (not shown) and an antenna (not shown) for transmitting and/or receiving data (e.g. emails, textual messages, phone calls, information corresponding to web pages). Unlike the previous embodiment, wherein the single shortcut key was provided as part of a personal keyboard, the single shortcut key (511a) of this example embodiment is configured to form part of the standard keyboard (511).

In this case, the device/apparatus is configured to provide, via an operating system, an messaging application, a web browser application and a messaging application. FIG. 5a depicts the electronic device when the messaging application is running. When an application is running the display is configured to show a running application region (532) corresponding to the running application (which is the messaging application in this case), and an application icon region (531) having an icon corresponding to each of the available applications. In the situation depicted in FIG. 5a, the running application region (532) comprises a list of messaging conversations. The user wishes to continue his messaging conversation with the remote contact ‘Craig’ and so selects the corresponding messaging conversation (532a) by pressing or hovering over the touch screen user interface.

FIG. 5b shows the device when the Craig messaging conversation is open. In this situation, the running messaging application comprises the last received message (532x) and an editable message (532y) which the user is preparing to reply to the last received message. In this case, the user has entered a message comprising a character string corresponding to where they want to meet. The user wishes to associate this character string with the single shortcut key (511a) in order to search the internet for cafés. Prior to the single shortcut key being associated with a character string, the single shortcut key is configured to comprise placeholder text (in this case ‘User defined’) to indicate that the character string associated with the single shortcut key (511a) may be defined by the user. To do this the user highlights the character string comprising the text ‘lace market’ by providing a particular gesture input via the touch screen. In this case the character string is highlighted using a bounding box (553).

In response to a character string being highlighted a pop-up menu (531) is provided comprising a number of icons including: an association icon (531a), configured to allow the user to associate the highlighted character string with the single shortcut key; a copy icon (531c), configured to allow the user to copy the highlighted text to a clipboard; and a paste icon (531 b), configured to allow the user to paste content from the clipboard.

In this case, the user selects the association icon (531a) which associates the highlighted character string (541) with the single shortcut key (511a) during highlighting of the character string. In this embodiment, when the single shortcut key is associated with a character string, the single shortcut key (511a) is configured to display the first predetermined number of characters of the associated character string, to provide an indication of at least part of the character string which can be entered. It will be appreciated that other example embodiments may not be configured to provide an indication of at least part of the character string which can be entered.

In this example, the user then wishes to find a café nearby by searching on the internet. The user opens the web browsing application by selecting the corresponding web browsing application icon (531b) from the available application icon region (531). This opens a search engine web page as a default page. In this case, the search engine web page comprises a text field (542a), which is a search field configured to allow the user to enter textual search terms. In this case the user enters the search term ‘Café’ (e.g. by manually selecting each character in turn from the standard keyboard (511)) and then presses (or actuates) the single shortcut key (511a). In this way, the ‘lace market’ character string is entered into the search text field (542a) at the position of the text entry cursor. In this way, the single shortcut key is available for entry of the character string in a different application to the application from which it was highlighted for association.

When the user has searched for this search string comprising the term ‘Café’ and the entered character string ‘lace market’ the closest cafés to the lace market are displayed as search results (indicated by stars) on a map (542b), as shown in FIG. 5f.

It will be appreciated that the single shortcut key may also be available in the messaging application. By making the location shortcut available to multiple applications, the burden on the user in entering character strings may be reduced.

In the above embodiment, the single shortcut key (511a) is provided as a virtual key. It will be appreciated that for other example embodiments, the single shortcut key may be a physical key. Multiple respective single shortcut keys can be provided.

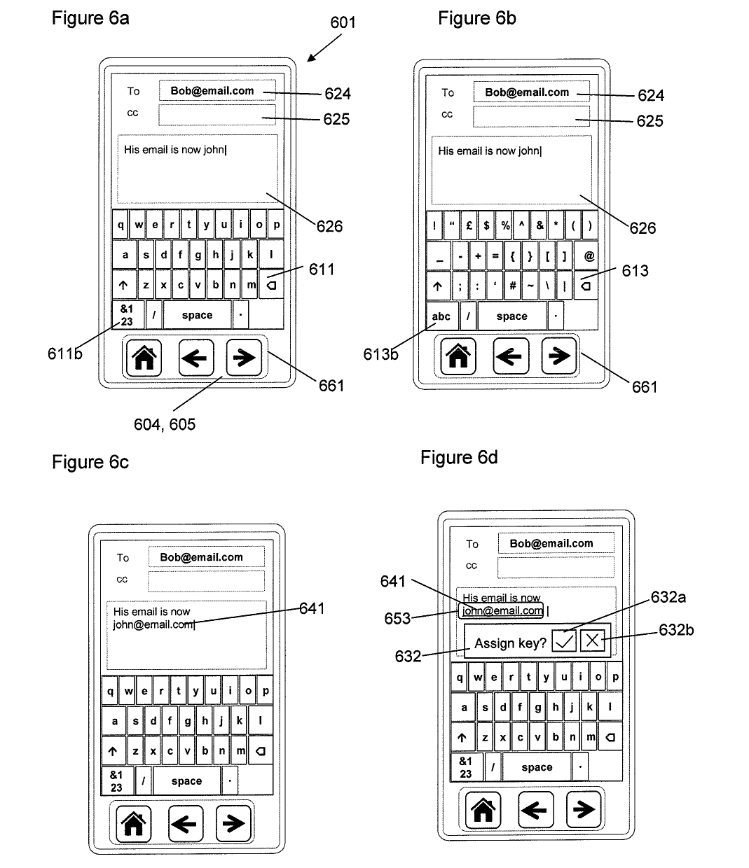

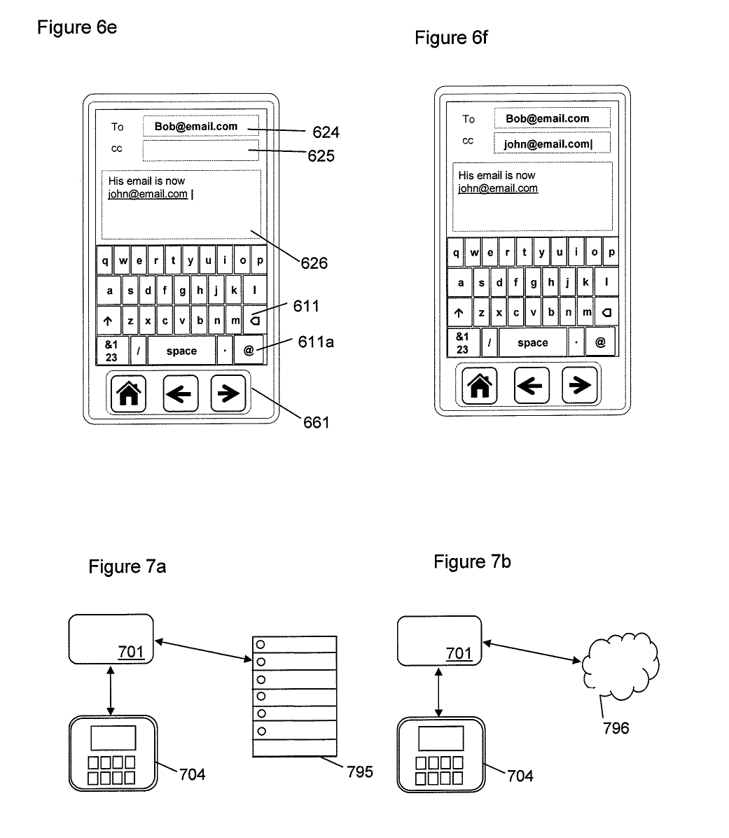

FIGS. 6a-6f depict a further example embodiment comprising a portable electronic device (601), e.g. such as a mobile phone, with a user interface comprising a touch-screen user interface (605, 604), a memory (not shown), a processor (not shown) and an antenna (not shown) for transmitting and/or receiving data (e.g. emails, textual messages, phone calls, information corresponding to web pages). Like the previous embodiment the single shortcut key (611 a) of this example embodiment is configured to form part of a standard keyboard (611). Unlike the previous example embodiments, this example embodiments is configured to automatically highlight the character string during active entry of the character string (e.g. in a particular field of a particular application) if the character string satisfies a particular predetermined one or more criterion. In this case the criterion comprises whether more than one keyboard is required to enter the character string.

In this case, the device/apparatus is configured to provide, via an operating system, an email application. FIG. 6a depicts the electronic device when the email application is running. When an application is running the display is configured to show a running application region configured to allow the user to compose an email comprising a ‘to’ text field (624) configured to allow the user to designate the recipients which the email is to be addressed to; a ‘cc’ (carbon copy) text field (625) to allow the user to designate other recipients of the email; and a ‘body’ text field (626) to allow the user to enter the text of the email message. The display is also configured to display a keyboard region (611), comprising a virtual keyboard; and an icon region (661) having icons configured to allow the user to navigate between applications which are available on the device.

In the situation depicted in FIG. 6a, the user is entering a message into the ‘body’ text field (626) comprising a number of word character strings and an email address character string (641). The user has already entered a number of word character strings and has started entering the email address character string. However, in order to enter the ‘@’ symbol character the user must switch the keyboard from the QWERTY standard keyboard (611) to a symbol keyboard by selecting the symbol keyboard key (611b). In response to the symbol keyboard key (611b) being selected, the standard QWERTY keyboard (611) is replaced by a symbol keyboard (613), the symbol keyboard as shown in FIG. 6b. Using the symbol keyboard (613) enables the user to enter the required one or more symbols before switching back to the standard QWERTY keyboard, using the standard keyboard key (613b), to complete the email address character string (as shown in FIG. 6c).

This example embodiment is configured to recognise that the email address character string has been entered when the space key has been selected (i.e. the space acts as a delimiter between constituent character strings). In response to the space key being selected after a character string comprising characters from a plurality of keyboards (in this case the standard keyboard (611) and the symbol keyboard (613)), the apparatus/device is configured to automatically highlight the character string (641) (in this case using a bounding box (653)) and provide a pop-up window (632) requesting confirmation as to whether the user wishes the highlighted character string to be associated with a single shortcut key. This is shown in FIG. 6d. In this case, the pop-up window comprises a confirm icon (632a), configured to allow the user to confirm the association of the character string with a single shortcut key; and a reject icon (632b), configured to allow the user to reject the association of the character string with a single shortcut key. In this case, the user wishes the highlighted email address to be associated with a single shortcut key and so selects the confirm icon of the pop-up window.

It will be appreciated that the apparatus may be configured to confirm or reject the association automatically or by default. For example, if the user were to continue typing using the virtual keyboard, the apparatus/device may be configured to automatically confirm or reject the association between the highlighted character string and the single shortcut key. Similarly, other example embodiments may be configured to automatically confirm or reject the association between the highlighted character string and the single shortcut key in response to the pop-up window being displayed for a time exceeding a predetermined time threshold without further user input.

It will be appreciated that other example embodiments may use other criteria for determining whether or not to automatically highlight the character string for association with a single shortcut key. For example, the one or more criterion may comprise one or more of determining whether the length of the character string exceeds a predetermined length threshold; determining whether the character string comprises a particular one or more characters/character sub-strings (e.g. ‘@’, ‘_’, ‘-’, ‘http’, ‘www.’, ‘.’).

In this case, the single shortcut key (611a) is a newly created shortcut key not available prior to the association. In this case, the newly created shortcut key (611a) forms part of the standard keyboard (611). In this case, the shortcut key is configured to display the first character of the associated character string (641) which was not entered using the standard keyboard (611). In this case the displayed character is the ‘@’ character which indicates to, and/or helps remind, the user that the associated character string is an email address (FIG. 6e).

The user then wishes to use the single shortcut key (611a) to enter the associated character string (641) into the ‘carbon copy’ text (625) field of the email. The user first moves the cursor to the ‘carbon copy’ field (625) of the email and then actuates the single shortcut key (611a). In response to the single shortcut key being actuated, the apparatus/device is configured to enable entering of the ‘john@email.com’ email address character string (641) into the ‘carbon copy’ text field (625) at the position of the text-entry cursor (as shown in FIG. 6f). The user thus does not have to type the email address.

In the above described embodiments, the single shortcut key enables the associated character string to be entered into the same device which enabled the highlighting of the character string. It will be appreciated that other example embodiments may be configured such that the association is done for a selected character string on a first electronic device for use by a single key of a keyboard on a second electronic device. For example, the association may be performed on a first portable electronic device and transmitted (e.g. via a network such as the internet or a cellular telephony network) to a second portable electronic device, such that in response to the single shortcut key being actuated on the second device, the associated character string may be entered into a text field of an application.

In each of the above described embodiments a pop-up menu or window is provided to allow the user to control/enable the association between the highlighted character string and the single shortcut key. It will be appreciated that other example embodiments may be configured to associate the highlighted character string with a single shortcut key in response to a particular user input (e.g. a particular key sequence, key combination, or a particular gesture input such as a circular gesture input). In such embodiments, a pop-up menu or window may or may not be provided. In some example embodiments the input may be a translational gesture extending between the highlighted character string and the single shortcut key (for example a drag and drop gesture) and where several single shortcut keys are available to be associated with character strings the translation gesture may define which is to be used with the currently highlighted character string (e.g. by ending on or close to that single shortcut key).

It will be appreciated that other embodiments may not be portable electronic devices. For example, an embodiment may comprise a desktop computer (wherein, for example, the association may be performed in response to selection of a menu item which is provided in response to right-clicking a mouse).

FIG. 7a shows that an example embodiment of an apparatus in communication with a remote server. FIG. 7b shows that an example embodiment of an apparatus in communication with a “cloud” for cloud computing. In FIGS. 7a and 7b, apparatus 701 (which may be apparatus 101, 201 or 301) is in communication with a display 704. Of course, the apparatus 701 and display 704 may form part of the same apparatus/device, although they may be separate as shown in the figures. The apparatus 701 is also in communication with a remote computing element. Such communication may be via a communications unit, for example. FIG. 7a shows the remote computing element to be a remote server 795, with which the apparatus may be in wired or wireless communication (e.g. via the internet, Bluetooth, a USB connection, or any other suitable connection as known to one skilled in the art). In FIG. 7b, the apparatus 701 is in communication with a remote cloud 796 (which may, for example, by the Internet, or a system of remote computers configured for cloud computing). It may be that the character string and/or at least some user applications are stored/run at the remote computing element 795, 796 and accessed by the apparatus 701 for display 704. The user applications and user event content need not all be stored at the same location.

Some or all of the user applications and/or user content may be stored at the apparatus 101, 201, 301, 701. Some or character strings and/or character string associations may be stored at the remote computing element 795, 796. The apparatus 701 may actually form part of the remote sever 795 or remote cloud 796. In such embodiments, the enablement of the association and/or the enablement of the entering of the associated character string may be conducted by the server or in conjunction with use of the server.

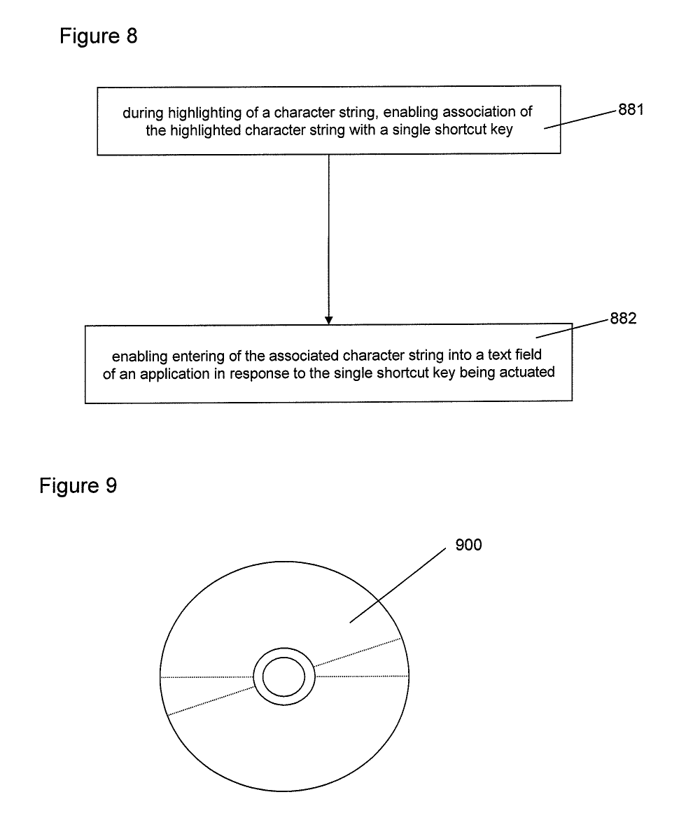

FIG. 8 illustrates the process flow according to an example embodiment of the present disclosure. The process comprises enabling (881) association of the highlighted character string with a single shortcut key during highlighting of a character string; and enabling (882) entering of the associated character string into a text field of an application in response to the single shortcut key being actuated.

FIG. 9 illustrates schematically a computer/processor readable medium (900) providing a program according to an embodiment. In this example, the computer/processor readable medium is a disc such as a Digital Versatile Disc (DVD) or a compact disc (CD). In other embodiments, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to example embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
during highlighting of a character string, enable association of the highlighted character string with a single shortcut key; and
enable entering of the associated character string into a text field of an application in response to the single shortcut key being actuated.

2. The apparatus of claim 1, wherein the apparatus is configured to provide the enablement of the association during the presentation of a virtual keyboard to a user.

3. The apparatus of claim 1, wherein the apparatus is configured to, during the highlighting of the character string, provide a pop-up menu to allow selection of the character string for association with the single shortcut key.

4. The apparatus of claim 1, wherein the apparatus is configured to, during the highlighting of the character string, provide a pop-up menu comprising at least two selectable options, a first selectable option allowing selection of the character string for association with the single shortcut key and the second selectable option allowing selection of the character string for storage in a copy memory for later pasting.

5. The apparatus of claim 1, wherein the apparatus is configured to, during the highlighting of the character string, allow selection of the character string for association with the single shortcut key.

6. The apparatus of claim 1, wherein the apparatus is configured to one of:
assign a subsequent selected character string to the same single shortcut key to replace the previously assigned character string for the single shortcut key; or
assign a subsequent selected character string to a different single shortcut key.

7. The apparatus of claim 1, wherein the single shortcut key is at least one of:
a newly created virtual key not available prior to the association;
a newly created virtual key not available prior to the association, the single shortcut key configured to populate a personal virtual keyboard; and
a newly created virtual key not available prior to the association, the single shortcut key configured to populate a personal virtual keyboard, the personal virtual keyboard configured to be accessible using an existing virtual key from a standard virtual keyboard.

8. The apparatus of claim 1, wherein the virtual keyboard comprises an alphanumeric keyboard, a numeric keyboard or an alphabetic keyboard.

9. The apparatus of claim 1, wherein the single shortcut key comprises an indication of at least part of the character string which can be entered.

10. The apparatus of claim 1, wherein the apparatus is configured to provide feedback on a selected association of the character string with the single shortcut key following the association.

11. The apparatus of claim 1, wherein the apparatus is configured to provide the enablement of the association with a single shortcut key at an operating system level common for a plurality of applications of an electronic device.

12. The apparatus of claim 1, wherein the single shortcut key is available for entry of the character string in a different application to the application from which it was highlighted for association.

13. The apparatus of claim 1, wherein the association is configured to persist after the application from which the character string was highlighted for association is closed.

14. The apparatus of claim 1, wherein the apparatus is configured to automatically highlight the character string during active entry of the character string in a particular field of a particular application.

15. The apparatus of claim 1, wherein the apparatus is configured to automatically highlight the character string during entry of a character string if the entered character string according to a particular predetermined length criterion or a predetermined character type criterion.

16. The apparatus of claim 1, wherein the apparatus is configured to determine that multiple standard keyboards have been used in the character entry prior to automatically providing highlighting the character string for association to a single key.

17. The apparatus of claim 1, wherein the apparatus is configured such that the association is done for a selected character string on a first electronic device for use by a single key of a keyboard on a second electronic device.

18. The apparatus of claim 1, wherein the apparatus is a portable electronic device, a laptop computer, a mobile phone, a Smartphone, a tablet computer, a personal digital assistant, a digital camera, a watch, a server, or a module/circuitry for one or more of the same a non-portable electronic device, a desktop computer, a monitor, a server, or a module/circuitry for one or more of the same.

19. A method, the method comprising:
during highlighting of a character string, enabling association of the highlighted character string with a single shortcut key; and
enabling entering of the associated character string into a text field of an application in response to the single shortcut key being actuated.

20. A computer program comprising computer program code, the computer program code being configured to perform at least the following:
during highlighting of a character string, enable association of the highlighted character string with a single shortcut key; and
enable entering of the associated character string into a text field of an application in response to the single shortcut key being actuated.
